(19) United States
(12) Patent Application Publication
(10) Pub. No.: US 2006/0220577 A1
(43) Pub. Date: Oct. 5, 2006

(54) Display and method of driving the same

(76) Inventor: Yoshiro Aoki, Kitamoto-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/386,710

(22) Filed: Mar. 23, 2006

(30) Foreign Application Priority Data
Mar. 31, 2005 (JP) 2005-104646

(51) Int. Cl. G09G 3/10

(52) U.S. Cl. 315/169.1; 315/169.3

(57) ABSTRACT

A display sequentially executes first and second operations during a write period. The first operation includes making a first constant-current flow through a video signal line while connecting a first terminal of a drive control element to a power supply terminal connecting a second terminal and control terminal of the drive control element to the video signal line. The second operation includes making a second constant-current flow through the video signal line in a flow direction of the first constant-current while breaking a connection between the first terminal and the power supply terminal and/or a connection between the second terminal and the control terminal and connecting the control terminal to the video signal line. The display causes a difference between grayscale levels by changing a time period during which the second constant-current flows through the video signal line.

### CROSS-REFERENCE TO RELATED APPLICATIONS

This application is based upon and claims the benefit of priority from prior Japanese Patent Application No. 2005-104646, filed Mar. 31, 2005, the entire contents of which are incorporated herein by reference.

### BACKGROUND OF THE INVENTION

1. Field of the Invention

The present invention relates to a display and a method of driving a display, and in particular, to a display that controls the optical characteristics of each display element using a current passed through the element, and a method of driving the display.

2. Description of the Related Art

In a display such as an organic electroluminescent (EL) display which controls the optical characteristics of each display element by a magnitude of a drive current passed through the display element, image quality deterioration such as luminance unevenness occurs if magnitudes of the drive currents vary. Therefore, when an active matrix driving method is used in this display, the pixels must be the same in the characteristics of a drive transistor for controlling the magnitude of the drive current. In this display, however, the drive transistors are normally formed on an insulator such as a glass substrate, so their characteristics easily vary.

U.S. Pat. No. 6,373,454 describes an organic EL display using a current mirror circuit in a pixel.

This pixel includes an n-channel field-effect transistor as the drive transistor, an organic EL element, and a capacitor. The source of the drive transistor is connected to a power supply line at a lower electric potential, and the capacitor is connected between the gate of the drive transistor and the power supply line. The anode of the organic EL element is connected to a power supply line at a higher electric potential.

The pixel circuit is driven as described below.

Firstly, the drain of the n-channel field-effect transistor is connected to its gate. A current I_{sig} at a magnitude corresponding to a magnitude of a video signal is made to flow between the drain and source of the n-channel field-effect transistor. This operation sets the voltage between electrodes of the capacitor, equal to a gate-to-source voltage necessary for the n-channel field-effect transistor to pass the current I_{sig} through its channel.

Then, the drain of the n-channel field-effect transistor is disconnected from its gate, and the voltage between the electrodes of the capacitor is maintained. The drain of the n-channel field-effect transistor is subsequently connected to the cathode of the organic EL element. This allows a drive current I_{drv} at a magnitude almost equal to that of the current I_{sig} to flow through the organic EL element. The organic EL element emits light at a luminance corresponding to the magnitude of the drive current I_{drv}.

The above configuration makes it possible for the drive current I_{drv}, which flows between the drain and source of the n-channel field-effect transistor during a retention period following a write period, to have a magnitude almost equal to a magnitude of the current I_{sig} supplied as a video signal during the write period. Therefore, the influence of not only the threshold value Vₜₕ but also the mobility, dimensions, and the like of the n-channel field-effect transistor on the drive current I_{drv} can be eliminated.

However, when the video signal I_{sig} corresponding the drive current I_{drv} of a small magnitude is written on the pixel, the display requires a relatively long time period for the voltage between the electrodes of the capacitor to change to a value to be set by the write operation. Accordingly, when a wiring capacitance of the video signal line is increased due to upsizing of the screen or when the write period is shortened due to an increase in the resolution, in particular, the write period may end before a change of the voltage between the electrodes of the capacitor to a value to be set by the write operation is completed.

In other words, an insufficient write may occur when a magnitude of the video signal I_{sig} is small. When such an insufficient write occurs in an organic EL display, each gray level within a low gray level range is displayed higher than the gray level to be displayed. Consequently, the contrast is lowered.

### BRIEF SUMMARY OF THE INVENTION

According to a first aspect of the present invention, there is provided a display comprising a video signal line, and pixels arranged along the video signal line, each of the pixels comprising a drive control element including a control terminal, a first terminal, and a second terminal which outputs a current at a magnitude corresponding to a voltage between the control terminal and the first terminal, a capacitor connected between a constant-potential terminal and the control terminal, and a display element whose optical characteristic changes in accordance with a magnitude of current flowing through the display element, wherein the display is configured to sequentially execute first and second operations during a write period and execute a display operation during an effective display period following the write period in a case where a grayscale level within a first grayscale range is to be displayed on the pixel, the first operation including making a first constant-current flow through the video signal line for a given length of time while connecting the first terminal to a first power supply terminal and connecting the second terminal and the control terminal to the video signal line, the second operation including making a second constant-current flow through the video signal line in a flow direction of the first constant-current while breaking a connection between the first terminal and the first power supply terminal and/or a connection between the second terminal and the control terminal and connecting the control terminal to the video signal line, and the display operation including making a drive current flow through the display element while breaking the connection between the second terminal and the control terminal and a connection between the control terminal and the video signal line, connecting the first terminal to the first power supply terminal, and connecting the display element between the second terminal and a second power supply terminal, and wherein the display is further configured to cause a difference between grayscale levels within the first grayscale range by changing a time period during which the second constant-current flows through the video signal line.

According to a second aspect of the present invention, there is provided a display comprising a video signal line driver, a video signal line connected to the video signal line driver, and a pixel which comprises a drive control element including a control terminal, a first terminal, and a second terminal which outputs a current at a magnitude corresponding to a voltage between the control terminal and the first terminal, a capacitor connected between a constant-potential terminal and the control terminal, and a display element whose optical characteristic changes in accordance with a magnitude of current flowing through the display element, wherein the display is configured to sequentially execute first and second operations, the first operation including making the video signal line driver output a first constant-current to the video signal line for a given length of time while connecting the first terminal to a power supply terminal and connecting the second terminal and the control terminal to the video signal line, and the second operation including making the video signal line driver output a second constant-current to the video signal line while connecting the first terminal to the power supply terminal and disconnecting the second terminal from the video signal line, and wherein the display is further configured to control the voltage between the control terminal and the first terminal in accordance with a time period over which the video signal line driver outputs the second constant-current to the video signal line.

According to a third aspect of the present invention, there is provided a method of driving a display comprising a video signal line, and pixels arranged along the video signal line, each of the pixels comprising a drive control element including a control terminal, a first terminal, and a second terminal which outputs a current at a magnitude corresponding to a voltage between the control terminal and the first terminal, a capacitor connected between a constant-potential terminal and the control terminal, and a display element whose optical characteristic changes in accordance with a magnitude of current flowing through the display element, comprising sequentially executing first and second operations during a write period and executing a display operation during an effective display period following the write period in a case where a grayscale level within a first grayscale range is to be displayed on the pixel, the first operation including making a first constant-current flow through the video signal line for a given length of time while connecting the first terminal to a first power supply terminal and connecting the second terminal and the control terminal to the video signal line, the second operation including making a second constant-current flow through the video signal line in a flow direction of the first constant-current while breaking a connection between the first terminal and the first power supply terminal and/or a connection between the second terminal and the control terminal and connecting the control terminal to the video signal line, and the display operation including making a drive current flow through the display element while breaking the connection between the second terminal and the control terminal and a connection between the control terminal and the video signal line, connecting the first terminal to the first power supply terminal, and connecting the display element between the second terminal and a second power supply terminal, and causing a difference between grayscale levels within the first grayscale range by changing a time period during which the second constant-current flows through the video signal line.

### BRIEF DESCRIPTION OF THE SEVERAL VIEWS OF THE DRAWING

FIG. 1 is a plan view schematically showing a display according to a first embodiment of the present invention;

FIG. 2 is a timing chart schematically showing an example of a method of driving the display shown in FIG. 1;

FIG. 3 is a diagram schematically showing an example of a structure which can be used as the video signal line driver of the display shown in FIG. 1;

FIG. 4 is a diagram schematically showing another example of a structure which can be used as the video signal line driver of the display shown in FIG. 1;

FIG. 5 is a diagram schematically showing still another example of a structure which can be used as the video signal line driver of the display shown in FIG. 1;

FIG. 6 is a timing chart schematically showing another example of a method of driving the display shown in FIG. 1;

FIG. 7 is a diagram schematically showing still another example of a structure which can be used as the video signal line driver XDR of the display shown in FIG. 1;

FIG. 8 is a diagram schematically showing still another example of a structure which can be used as the video signal line driver XDR of the display shown in FIG. 1;

FIG. 9 is an equivalent circuit diagram showing a modified example of the pixel;

FIG. 10 is an equivalent circuit diagram showing another modified example of the pixel PX; and

FIG. 11 is an equivalent circuit diagram showing still another modified example of the pixel.

### DETAILED DESCRIPTION OF THE INVENTION

Embodiments of the present invention will be described below in detail with reference to the drawings. In the drawings, components achieving the same or similar functions are denoted by the same reference numerals and duplicate descriptions will be omitted.

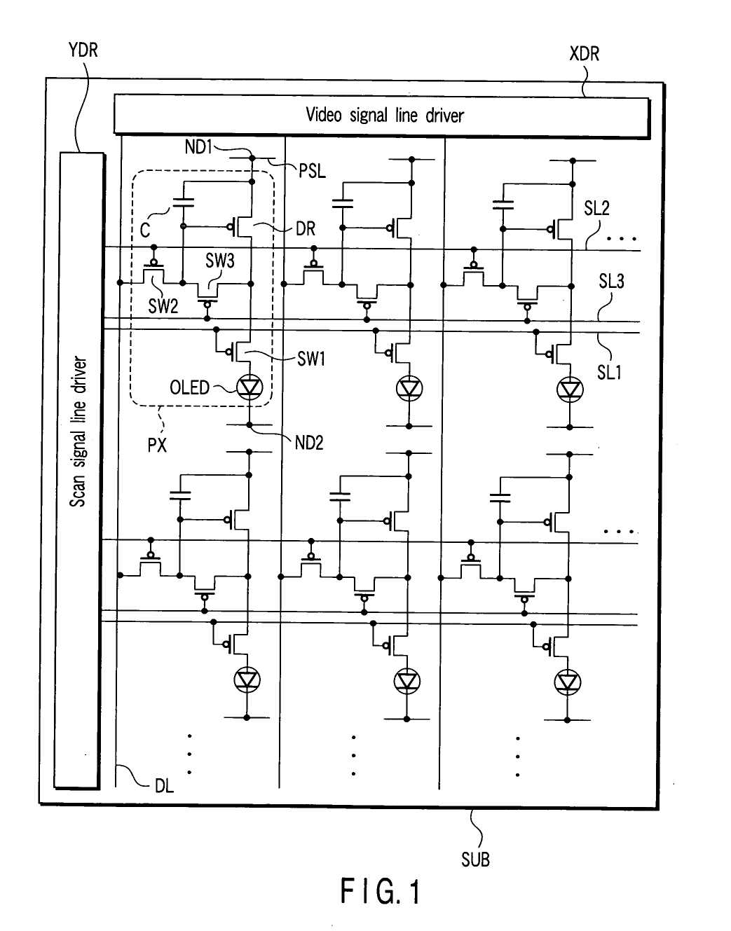

FIG. 1 is a plan view schematically showing a display according to a first embodiment of the present invention. The display is, for example, an organic EL display including a plurality of pixels PX arranged in a matrix on an insulating substrate SUB.

A scan signal line driver YDR and a video signal line driver XDR are further placed on the substrate SUB. The video signal line driver XDR will be described later in detail.

Scan signal lines SL1 to SL3 extend along rows of the pixels on the substrate SUB and are connected to the scan signal line driver YDR. The scan signal line driver YDR supplies the scan signal lines SL1 to SL3 with scan signals as voltage signals.

Video signal lines DL extend along columns of the pixels on the substrate SUB and are connected to the video signal line driver XDR. The video signal line driver XDR supplies the video signal lines DL with reset signals and video signals.

Further, power supply lines PSL are arranged on the substrate SUB.

Each pixel PX includes a drive control element DR, first to third switches SW1 and SW3, a capacitor C, and a display element OLED.

The display element OLED includes an anode, a cathode facing the anode, and an active layer whose optical characteristics change in accordance with the magnitude of the current flowing between the anode and cathode. Here, by way of example, the display element OLED is an organic EL element including an emitting layer as an active layer. By way of example, the anode is a lower electrode, and the cathode is an upper electrode facing the lower electrode with the active layer interposed therebetween.

The drive control element DR includes a first terminal, a control terminal, and a second terminal that outputs a current at a magnitude corresponding to the voltage between the first terminal and the control terminal. Here, by way of example, a p-channel thin-film transistor (TFT) is used as the drive control element DR. The control terminal, i.e., a gate, of the drive control element DR is connected to one electrode of the capacitor C. The first terminal, i.e., a source, of the drive control element DR is connected to the power supply line PSL. A node ND1 on the power supply line PSL corresponds to a first power supply terminal.

The switch SW1 and the display element OLED are connected in series between the second terminal of the drive control element DR and a second power supply terminal ND2. A switching operation of the switch SW1 is controlled by a scan signal supplied by the scan signal line driver YDR via the scan signal line SL1.

In this embodiment, the switch SW1 and the display element OLED are connected in series between the second terminal of the drive control element DR and the second power supply terminal ND2 in this order. In this embodiment, a p-channel TFT is used as the switch SW1, and its gate is connected to the scan signal line SL1. A source and drain of the switch SW1 are connected to the drain of the drive control element DR and the anode of the organic EL element OLED, respectively. The display element OLED and the switch SW1 may be connected in series between the second terminal of the drive control element DR and the second power supply terminal ND2 in this order.

The switch SW2 is connected between the control terminal of the drive control element DR and the video signal line DL. A switching operation of the switch SW2 is controlled by a scan signal supplied by the scan signal line driver YDR via the scan signal line SL2. In this embodiment, a p-channel TFT is used as the switch SW2, and its gate is connected to the scan signal line SL2. A source and drain of the switch SW2 are connected to the gate of the drive control element DR and the video signal line DL, respectively.

The switch SW3 is connected between the second terminal and control terminal of the drive control element DR. A switching operation of the switch SW3 is controlled by a scan signal supplied by the scan signal line driver YDR via the scan signal line SL3. In this embodiment, a p-channel TFT is used as the switch SW3, and its gate is connected to the scan signal line SL3. A source and drain of the switch SW3 are connected to the drain and gate of the drive control element DR, respectively.

The capacitor C is connected between a constant-potential terminal and the control terminal of the drive control element DR. Here, by way of example, the capacitor C is connected between the node ND1 on the power supply line PSL and the gate of the drive control element DR. The constant-potential terminal to which the capacitor C is connected may be electrically isolated from the power supply line PSL. That is, another constant-potential terminal electrically isolated from the power supply line PSL may be utilized.

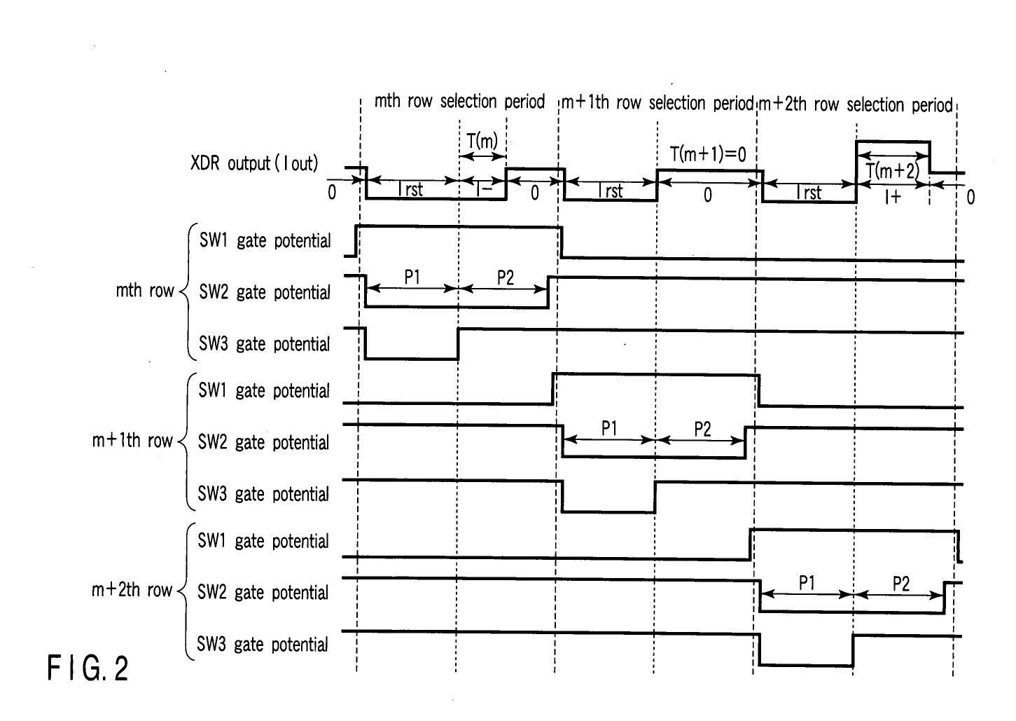

FIG. 2 is a timing chart schematically showing an example of a method of driving the display shown in FIG. 1.

In FIG. 2, the abscissa indicates time, while the ordinate indicates the magnitude of potential or current. In this figure, the waveform shown as an “XDR output (Iₒᵤₜ)” shows an example of a current which the video signal line driver XDR makes flow through each video signal line DL. The waveform shown as an “SW1 gate potential” shows the gate potential of the switch SW1. The waveform shown as an “SW2 gate potential” shows the gate potential of the switch SW2. The waveform shown as an “SW3 gate potential” shows the gate potential of the switch SW3. “Iᵣₛₜ” denotes a constant-current made to flow from the pixel PX to the video signal line driver XDR via the video signal line DL. “I₋” denotes a constant-current made to flow in the same direction as that of “Iᵣₛₜ”. “I₊” denotes a constant-current made to flow in the direction opposite to that of “Iᵣₛₜ”. “T(m+k)” denotes the time period over which the “constant-current I₋” or “constant-current I₊” is made to flow through the video signal line DL while the switch SW2 of a pixel PX in an m+k-th row is closed with its switch SW3 open.

The method shown in FIG. 2 divides the whole gray level range into a first gray level range which corresponds to drive currents of a smaller magnitude, and a second gray level range which corresponds to drive currents of a larger magnitude. Further, the method shown in FIG. 2 employs different write operations in the case of displaying a gray level within the first gray level range and in the case of displaying a gray level within the second gray level range. FIG. 2 shows an example in which the pixels PX in an m-th row and an m+1-th row display gray levels within the first gray level range and the pixel in an m+2-th row displays a gray level within the second gray level range.

According to the method shown in FIG. 2, when a gray level within the first gray level range is displayed, the display shown in FIG. 1 is driven by the method described below.

For example, during a period over which pixels PX in the m-th row are selected, that is, during an m-th row selection period, the switch SW1 in each selected pixel PX is opened. During a write period, the switch SW1 is kept open, and first and second operations are sequentially executed.

During a first period P1 in which the first operation is executed, the switches SW2 and SW3 are closed. In this state, the first constant-current Iᵣₛₜ is made to flow from the power supply line PSL to the video signal line driver XDR via the drive control element DR, switches SW3 and SW2, and video signal line DL. This sets the gate-to-source voltage of the drive control element TR at a value obtained when the first current Iᵣₛₜ flows between the source and drain of the drive control element TR. The gate-to-source voltage is defined as Vᵣₛₜ.

A certain time period has elapsed after starting the first operation, the switch SW3 is opened and the current Iₒᵤₜ, which the video signal line driver XDR makes flow through each video signal line DL, is switched from the first constant-current Iᵣₛₜ to the second constant current I₋. Alternatively, the switch SW3 is opened and the current Iₒᵤₜ is set at zero. This ends the first operation.

In FIG. 2, the magnitude of the first constant-current Iᵣₛₜ is equal to that of the second constant-current I₋. The magnitudes may be different. For example, the second constant-current I₋ may be larger than the first constant-current Iᵣₛₜ. During a second period P2 in which the second operation is executed, the second constant-current I₋ is made to flow from the video signal line DL to the video signal line driver XDR while the switch SW2 is closed and the switch SW3 is opened. This causes electrons to move between the video signal line driver XDR and the video signal line DL or the electrode of the capacitor C connected to the gate of the drive control element DR. In this embodiment, electrons move from the video signal line driver XDR to the video signal line DL and the electrode of the capacitor C connected to the gate of the drive control element DR. As a result, the gate-to-source voltage of the drive control element DR changes from the value Vᵣₛₜ by a magnitude ΔV corresponding to a time period T over which the second constant-current I₋ is made to flow. That is, the gate-to-source voltage of the drive control element DR changes to a value Vᵣₛₜ−ΔV.

According to the present embodiment, the time period T is changed within a second period, that is, a period after the switch SW3 is opened and before the switch SW2 is opened, so as to cause a difference between grayscale levels within the first grayscale range. FIG. 2 shows an example that the time period T is set at T(m) in the second operation onto the pixel in the m-th row and the time period T is set at T(m+1)=0 in the second operation onto the pixel in the m+1-th row.

It is noted that the voltage change ΔV varies depending on the magnitude I of the second constant-current I₋, the time period T over which the second constant-current I₋ is made to flow, a wiring capacitance of the video signal line DL, and a capacitance of the capacitor C. The wiring capacitance C_{dl} of the video signal line DL is much larger than the capacitance of the capacitor C and the like. Although it depends on the size of the pixel, the wiring capacitance C_{dl} of the video signal line DL is, for example, about 20 to about 100 times larger than the capacitance of the capacitor C. Therefore, using the magnitude I of the second constant-current I₋, the time period T over which the second constant-current I₋ is made to flow, and the wiring capacitance C_{dl} of the video signal line DL, the voltage change ΔV can be expressed by an equation shown below.
ΔV=(I/C)×T

When the wiring capacitance of the video signal line DL is small, a capacitor may be connected between the video signal line and a constant-potential terminal.

After the time period T has elapsed from starting the second operation, the current Iₒᵤₜ which the video signal line driver XDR makes flow through each video signal line DL is changed from the second constant-current I₋ to zero. Thus, the gate-to-source voltage Vᵣₛₜ−ΔV of the drive control element DR just after the time period T has elapsed from starting the second operation is maintained.

After a certain time period has elapsed from starting the second operation, the switch SW2 is opened. Thus, the second operation is finished.

The switch SW1 is closed simultaneously with finishing the second operation or after finishing the second operation. Since the gate-to-source voltage of the drive control element DR is maintained at Vᵣₛₜ−ΔV until the switch SW2 and/or the switch SW3 is closed, a drive current at a magnitude almost in proportional to the square of the voltage Vᵣₛₜ−ΔV flows through the display element OLED.

According to the method shown in FIG. 2, when a gray level within the second gray level range is displayed, the display shown in FIG. 1 is driven by the method described below.

For example, during a period over which pixels PX in the m+2-th row are selected, that is, during an m+2-th row selection period, the switch SW1 in each selected pixel PX is opened. In the first period P1 of the write period, the switch SW1 is kept open, and the first operation, which is executed on the pixels PX in the m-th row, is executed on each pixel PX in the m+2-th row. This sets the gate-to-source voltage of the drive control element DR at a value Vᵣₛₜ when the first constant-current Iᵣₛₜ flows between the source and drain of the drive control element DR.

A certain time period has elapsed after starting the first operation, the switch SW3 is opened and the current Iₒᵤₜ, which the video signal line driver XDR makes flow through each video signal line DL, is switched from the first constant-current Iᵣₛₜ to the third constant current I₊ whose flow direction is opposite to that of the first constant-current Iᵣₛₜ. Alternatively, the switch SW3 is opened and the current Iₒᵤₜ is set at zero. This ends the first operation.

During the second period P2 following the first period P1, not the second operation described for the pixel PX in the m-th row but the third operation is executed as described below. Firstly, the constant current I₊ is made to flow from the video signal line driver XDR to the video signal line DL while the switch SW2 is closed and the switch SW3 is opened. This causes electrons to move between the video signal line driver XDR and the video signal line DL or the electrode of the capacitor C connected to the gate of the drive control element DR. In this embodiment, electrons move from the video signal line driver XDR and the video signal line DL and the electrode of the capacitor C connected to the gate of the drive control element DR to the video signal line driver XDR. As a result, the gate-to-source voltage of the drive control element DR changes from the value Vᵣₛₜ by a magnitude ΔV corresponding to a time period T over which the constant-current I₊ is made to flow. That is, the gate-to-source voltage of the drive control element DR changes to a value Vᵣₛₜ−ΔV.

After the time period T has elapsed from starting the third operation, the current Iₒᵤₜ which the video signal line driver XDR makes flow through each video signal line DL is changed from the constant-current I₊ to zero. Thus, the gate-to-source voltage Vᵣₛₜ−ΔV of the drive control element DR just after the time period T has elapsed from starting the second operation is maintained.

After a certain time period has elapsed from starting the third operation, the switch SW2 is opened. Thus, the third operation is finished.

The switch SW1 is closed simultaneously with finishing the third operation or after finishing the third operation. Since the gate-to-source voltage of the drive control element DR is maintained at Vᵣₛₜ−ΔV until the switch SW2 and/or the switch SW3 is closed, a drive current at a magnitude almost in proportional to the square of the voltage Vᵣₛₜ−ΔV flows through the display element OLED.

As described above, the direction of the constant current I₊ is opposite to that of the constant current I₋. Thus, the voltage change ΔV in the gate-to-source voltage of the drive control element DR caused by passing the constant current I₊ has a polarity opposite to that of the voltage change ΔV caused by the passing the constant current I₋. Therefore, by changing the time period T within the second period, that is, the period after the switch SW3 is opened and before the switch SW2 is opened, it is possible to cause a difference between grayscale levels within the second grayscale range.

As described above, the above method firstly executes the first operation to set the gate-to-source voltage of the drive control element DR at Vᵣₛₜ. When the magnitude of the first constant current Iᵣₛₜ made to flow by the first operation is set at a sufficiently large value, the gate-to-source voltage of the drive control element DR can be set at the value Vᵣₛₜ in a relatively short time after starting the first operation. That is, the time period allocated to the first period P1 may be relatively short.

The above method further executes the second or third operation to change the gate-to-source voltage of the drive control element DR from Vᵣₛₜ to Vᵣₛₜ−ΔV. When the voltage change ΔV is zero, it is possible to completely eliminate the influence of the variation in characteristics of the drive control elements DR on the drive currents. Even when the voltage change ΔV is not zero, it is possible to sufficiently eliminate the influence of the variation in characteristics of the drive control elements DR on the drive currents.

In addition, the parameters determining the voltage change ΔV, that is, the magnitude I of the second constant-current I₋ or the third constant-current I₊, the time period over which the constant-current is made to flow, and the wiring capacitance C_{dl} of the video signal line DL can be controlled precisely. Thus, the voltage change ΔV unlikely to have an error. Therefore, the voltage change ΔV can be precisely controlled even when the absolute value of the second constant-current I₋ or the third constant-current I₊ is large and the time period T is short. That is, the time period allocated to the second period P2 may be relatively short.

According to the method, it is, thus, possible to sufficiently suppress the influence of the variation in characteristics of the drive control elements DR on the drive currents, and therefore, it is possible to suppress the low contrast due to the insufficient write.

In the present embodiment, the video signal line driver XDR can employ various structures.

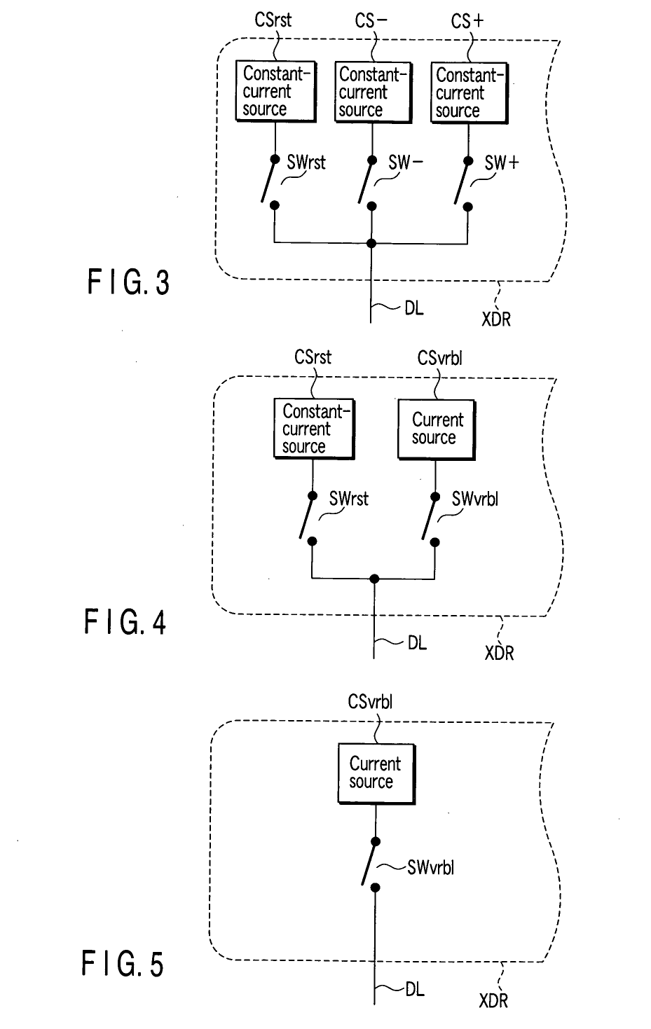

FIG. 3 is a diagram schematically showing an example of a structure which can be used as the video signal line driver XDR of the display shown in FIG. 1.

The video signal line driver XDR includes three constant-current sources CSᵣₛₜ, CS₋, and CS₊ for each video signal line DL. The constant-current source CSᵣₛₜ generates the above constant-current Iᵣₛₜ, which flows from the video signal line DL to the video signal line driver DL. The constant-current source CS₋ generates the above constant-current I₋, which flows through the video signal line DL in the same direction as that of the constant-current Iᵣₛₜ. The constant-current source CS₊ generates the above constant-current I₊, which flows through the video signal line DL in the direction opposite to that of the constant-current Iᵣₛₜ.

The constant-current source CSᵣₛₜ is connected to the video signal line DL via the switch SWᵣₛₜ. For example, a switching operation of the switch SWᵣₛₜ is controlled such that it is closed on a certain cycle in synchronization with the closure of the switches SW2 and SW3, and is opened on a certain cycle in synchronization with the opening of the switch SW3.

The constant-current source CS₋ is connected to the video signal line DL via the switch SW₋. For example, a switching operation of the switch SW₋ is controlled such that it is closed in synchronization with the start of the second period P2, which is repeated on a certain cycle, and is opened at the time when the time period T corresponding to the gray level has elapsed from the start of the second period P2, only in the case where a gray level within the first gray level range is to be displayed on the selected pixel PX.

The constant-current source CS₊ is connected to the video signal line DL via the switch SW₊. For example, a switching operation of the constant-current source CS₊ is controlled such that it is closed in synchronization with the start of the second period P2, which is repeated on a certain cycle, and is opened at the time when the time period T corresponding to the gray level has elapsed from the start of the second period P2, only in the case where a gray level within the second gray level range is to be displayed on the selected pixel PX.

FIG. 4 is a diagram schematically showing another example of a structure which can be used as the video signal line driver XDR of the display shown in FIG. 1.

This video signal line driver XDR includes two current sources, that is, a constant-current source CSᵣₛₜ and a current source CS_{vrbl} for each video signal line DL. The constant-current source CSᵣₛₜ is connected to the video signal line DL via the switch SWᵣₛₜ. The current source CS_{vrbl} is connected to the video signal line DL via the switch SW_{vrbl}. That is, this video signal line driver XDR has a structure similar to that of the video signal line driver XDR in FIG. 3 except that the current source CS_{vrbl} is used instead of the constant-current sources CS₋ and CS₊ and the switch SW_{vrbl} is used instead of the switches SW₋ and SW₊.

The current source CS_{vrbl} can generate at least the above constant-current I₋ which flows through the video signal line DL in the same direction as that of the constant-current Iᵣₛₜ and the above constant-current I₊ which flows through the video signal line DL in the direction opposite to that of the constant-current Iᵣₛₜ. The current source CS_{vrbl} generates the constant current I₋ when a gray level within the first gray level range is to be displayed on the selected pixel PX, and generates the constant current I₊ when a gray level within the second gray level range is to be displayed on the selected pixel PX. For example, a switching operation of the switch SW_{vrbl} is controlled such that it is closed in synchronization with the start of the second period P2, which is repeated on a certain cycle, and is opened at the time when the time period T corresponding to the gray level has elapsed from the start of the second period P2.

When magnitudes of the constant-current Iᵣₛₜ and the constant-current I₋ are equal to each other in the video signal line drivers XDR shown in FIGS. 3 and 4, the constant-current source CSᵣₛₜ and the switch SWᵣₛₜ may be omitted if the constant-current source CS₋ and the switch SW₋ play the roles of the constant-current source CSᵣₛₜ and the switch SWᵣₛₜ, respectively.

FIG. 5 is a diagram schematically showing another example of a structure which can be used as the video signal line driver XDR of the display shown in FIG. 1.

This video signal line driver XDR includes one current source CS_{vrbl} for each video signal line DL. The current source CS_{vrbl} is connected to the video signal line DL via the switch SW_{vrbl}.

In the video signal line driver XDR shown in FIG. 5, the current source CS_{vrbl} can generate at least the constant-current Iᵣₛₜ, the constant-current I₋ which flows through the video signal line DL in the same direction as that of the constant-current Iᵣₛₜ, and the constant-current I₊ which flows through the video signal line DL in the direction opposite to that of the constant-current Iᵣₛₜ. The current source CS_{vrbl} generates the constant-current Iᵣₛₜ during each first period P1, generates the constant-current I₋ during the second period P2 in the case where a gray level within the first gray level range is to be displayed on the selected pixel PX, and generates the constant-current I₊ during the second period P2 in the case where a gray level within the second gray level range is to be displayed on the selected pixel PX. For example, a switching operation of the switch SW_{vrbl} is controlled such that it is closed on a certain cycle in synchronization with the closure of the switches SW2 and SW3, opened on a certain cycle in synchronization with the opening of the switch SW3, closed in synchronization with the start of the second period P2, which is repeated on a certain cycle, and opened at the time when the time period T corresponding to the gray level has elapsed from the start of the second period P2.

Thus, in the display according to the first embodiment, it is sufficient for the video signal line driver XDR to generate three constant-currents, and in some cases, two constant-currents. Therefore, the structure of the video signal line driver XDR can be simplified.

Now, a second embodiment of the present invention will be described.

In the display according to the first embodiment, when the voltage change AV is increased, the effect of suppressing the influence that the variation in characteristics of the drive control elements DR has on the drive currents is decreased. In the second embodiment, the following write operation is executed in the case where a gray level within the second gray level range is to be displayed, so as to effectively suppress the influence of the variation in characteristics of the drive control elements DR on the drive currents.

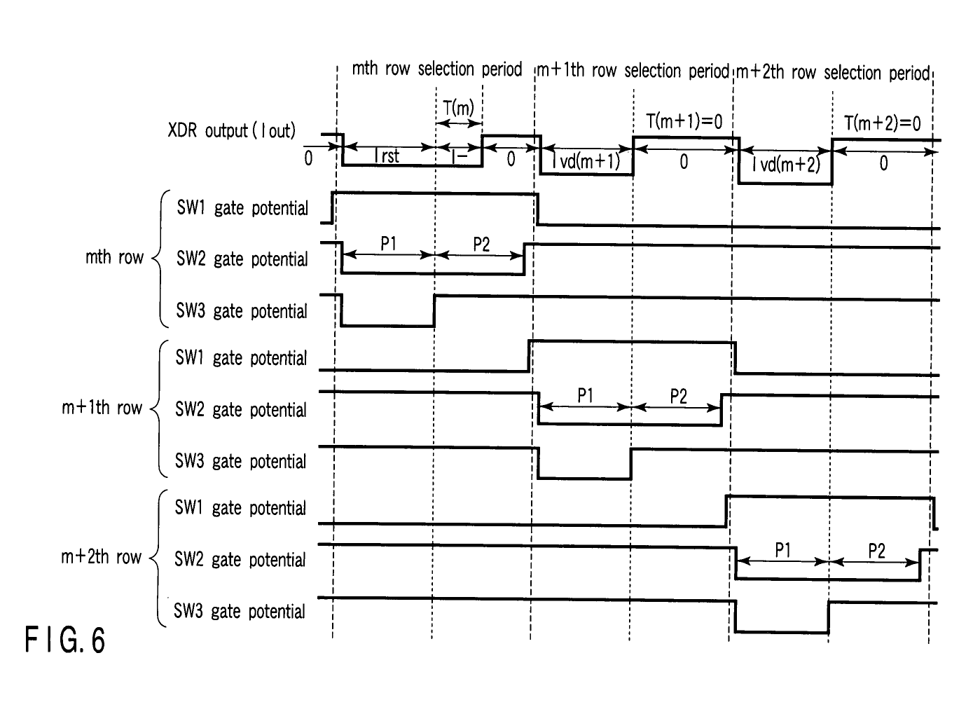

FIG. 6 is a timing chart schematically showing another example of a method of driving the display shown in FIG. 1.

The timing chart shown in FIG. 6 is similar to that shown in FIG. 2 except for the waveform shown as “XDR output (Iₒᵤₜ)”, that is, the waveform of the current which the video signal line driver XDR makes flow through each video signal line DL. In FIG. 6, “I_{vd} (m+k)” denotes a current which has a magnitude corresponding to a gray level within the second gray level range to be displayed on pixels PX in an m+k-th row and which is made to flow from the pixel PX in the m+k-th row to the video signal line driver XDR via the video signal lines DL. “T (m+k)” denotes the time period over which the “constant-current I” is made to flow through the video signal line DL while the switch SW2 is closed and the switch SW3 is opened in the pixel in the m+k-th row.

Similarly to the method shown in FIG. 2, the method shown in FIG. 6 divides the whole gray level range into the first gray level range which corresponds to drive currents of a smaller magnitude, and the second gray level range which corresponds to drive currents of a larger magnitude. Further, the method shown in FIG. 6 employs different write operations in the case of displaying a gray level within the first gray level range and in the case of displaying a gray level within the second gray level range. FIG. 6 shows an example in which the pixel PX in an m-th row display gray levels within the first gray level range and the pixels in an m+1-th row and an m+2-th row display a gray level within the second gray level range.

According to the method shown in FIG. 6, when a gray level within the first gray level range is displayed, the display shown in FIG. 1 is driven by the same method as that described with reference to FIG. 2. According to the method shown in FIG. 6, when a gray level within the second gray level range is displayed, the display shown in FIG. 1 is driven by the method described below.

For example, during a period over which the pixels PX in the m+1-th row are selected, that is, during an m+l-th row selection period, the switch SW1 in each selected pixel PX is opened. During a write period over which the switch SW1 is opened, fourth and fifth operations are sequentially executed.

During a first period P1 in which the forth operation is executed, the switches SW2 and SW3 are closed. In this state, a current I_{vd} at a magnitude equal to that of a drive current to be passed through the display element OLED is made to flow from the power supply line PSL to the video signal line driver XDR via the drive control element DR, the switch SW3, the switch SW2, and the video signal line DL. This sets the gate-to-source voltage of the drive control element TR at a value V_{dr} obtained when the drive current flows between the source and drain of the drive control element TR.

Typically, the absolute value of the constant-current Iᵣₛₜ is equal to or less than the minimum absolute value of the current I_{vd}. In the case that the time period T is longer than zero when a gray level within the first gray level range is displayed, the absolute value of the constant-current Iᵣₛₜ may be larger than the minimum absolute value of the current I_{vd}. A certain time period has elapsed after starting the fourth operation, the switch SW3 is opened and the current Iₒᵤₜ, which the video signal line driver XDR makes flow through each video signal line DL, is set at zero. This ends the fourth operation.

During a second period P2 in which the fifth operation is executed, the current which the video signal line driver XDR makes flow through the video signal line DL is set at zero while the switch SW2 is kept closed and the switch SW3 is kept open. Thus, the gate-to-source voltage of the drive control element DR is maintained.

After a certain time period has elapsed from starting the fifth operation, the switch SW2 is opened. Thus, the fifth operation is finished.

The switch SW1 is closed simultaneously with finishing the fifth operation or after finishing the fifth operation. Since the gate-to-source voltage of the drive control element DR is maintained at V_{dr} until the switch SW2 and/or the switch SW3 is closed, a drive current at a magnitude almost in proportional to the square of the voltage V_{dr} flows through the display element OLED.

As described above, according to the method, when a gray level within the second gray level range is displayed, the gate-to-source voltage of the drive control element DR is set to voltage V_{dr} by passing the current I_{vd} through the video signal line DL at a magnitude equal to that of the drive current corresponding to the gray level during the first period P1, and the gate-to-source voltage is maintained during the second period P2 and the effective display period. Therefore, when a gray level within the second gray level range is displayed, it is possible to completely eliminate the influence of the variation in characteristics of the drive control elements DR on the drive currents.

In addition, the drive current corresponding to a gray level within the second gray level range is larger than the drive current corresponding to a gray level within the first gray level range. Therefore, the gate-to-source voltage of the drive control element DR can be set to the voltage V_{dr} in a relatively short time period from starting the fourth operation.

According to the method, it is, thus, possible to more effectively suppress the influence of the variation in characteristics of the drive control elements DR on the drive currents, and therefore, it is possible to suppress the low contrast due to the insufficient write.

In the present embodiment, the video signal line driver XDR can employ various structures.

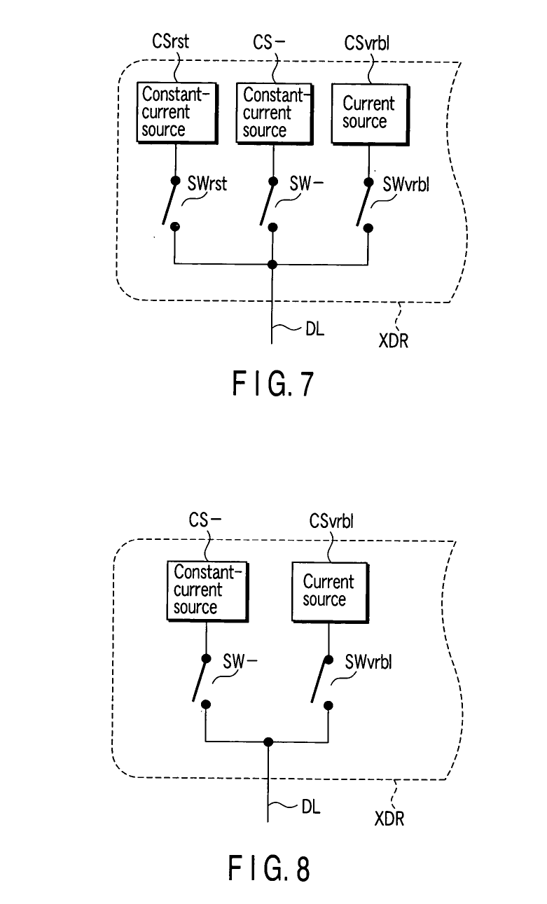

FIG. 7 is a diagram schematically showing another example of a structure which can be used as the video signal line driver XDR of the display shown in FIG. 1.

This video signal line driver XDR includes three current sources, that is, a constant-current source CSᵣₛₜ, a constant-current source CS₋, and a current source CS_{vrbl} for each video signal line DL. The constant-current source CSᵣₛₜ generates the constant-current Iᵣₛₜ which flows from the video signal line DL to the video signal line driver XDR. The constant-current source CS₋ generates the constant-current I₋ which flows through the video signal line DL in the same direction as that of the constant-current Iᵣₛₜ. The current source CS_{vrbl} generates the current I_{vd} which flows through the video signal line DL in the same direction as that of the constant-current Iᵣₛₜ at a magnitude corresponding to the magnitude of the drive current to be passed through the display element OLED.

The constant-current source CSᵣₛₜ is connected to the video signal line DL via the switch SWᵣₛₜ. For example, a switching operation of the switch SWᵣₛₜ is controlled such that it is closed in synchronization with the closure of the switches SW2 and SW3, and is opened on a certain cycle in synchronization with the opening of the switch SW3, only in the case where a gray level within the first gray level range is to be displayed on the selected pixel PX.

The constant-current source CS₋ is connected to the video signal line DL via the switch SW₋. For example, a switching operation of the switch SW₋ is controlled such that it is closed in synchronization with the start of the second period P2, which is repeated on a certain cycle, and is opened at the time when the time period T corresponding to the gray level has elapsed from the start of the second period P2, only in the case where a gray level within the first gray level range is to be displayed on the selected pixel PX.

The current source CS_{vrbl} is connected to the video signal line DL via the switch SW_{vrbl}. For example, a switching operation of the switch SW_{vrbl} is controlled such that it is closed in synchronization with the closure of the switches SW2 and SWe, and is opened in synchronization with the opening of the switch SW3, only in the case where a gray level within the second gray level range is to be displayed on the selected pixel PX.

FIG. 8 is a diagram schematically showing another example of a structure which can be used as the video signal line driver XDR of the display shown in FIG. 1.

This video signal line driver XDR includes two current sources, that is, a constant-current source CS₋ and a current source CS_{vrbl} for each video signal line DL. The constant-current source CS₋ is connected to the video signal line DL via the switch SW₋. The current source CS_{vrbl} is connected to the video signal line DL via the switch SW_{vrbl}. That is, the video signal line driver XDR has the same structure as that shown in FIG. 7 except that the constant-current source CSᵣₛₜ and the switch SWᵣₛₜ are omitted.

In the video signal line driver XDR shown in FIG. 8, the current source CS_{vrbl} generates the constant current Iᵣₛₜ, in addition to generates the current I_{vd} at a magnitude corresponding to the magnitude of the drive current to be passed through the display element. The current source CS_{vrbl} generates the constant-potential Iᵣₛₜ during the first period P1 when a gray level within the first gray level range is to be displayed on the selected pixel PX, and generates the current I_{vd} during the first period P1 at a magnitude corresponding to the magnitude of the drive current to be passed through the display element OLED when a gray level within the second gray level range is to be displayed on the selected pixel PX.

In the video signal line driver XDR shown in FIG. 8, the current source CS_{vrbl} generates the constant-potential Iᵣₛₜ when a gray level within the first gray level range is to be displayed on the selected pixel PX, and generates the current I_{vd} when a gray level within the second gray level range is to be displayed on the selected pixel PX. For example, a switching operation of the switch SW_{vrbl} is controlled such that it is closed in synchronization with the closure of the switches SW2 and SWe, and is opened in synchronization with the opening of the switch SW3.

In the second embodiment, the video signal line XDR may employ the structure shown in FIG. 5. In this case, utilized as the constant-current source CS_{vrbl} is the one that can generate the current I_{vd} flowing through the video signal line DL in the same direction as that of the constant-current Iᵣₛₜ at a magnitude corresponding to the magnitude of the drive current to be passed through the display element OLED, and generate the constant-currents Iᵣₛₜ and I₋. The current source CS_{vrbl} generates the constant-current Iᵣₛₜ during the first period P1, generates the constant-current I₋ during the second period P2, and generates the current I_{vd} during the first period P1 at a magnitude corresponding to the magnitude of the drive current to be passed through the display element OLED in the case where a gray level within the second gray level range is to be displayed on the selected pixel PX.

When the video signal line driver XDR employs the structure shown in FIG. 5, a switching operation of the switch SWᵣₛₜ is controlled, for example, such that it is closed on a certain cycle in synchronization with the closure of the switches SW2 and SWe, and is opened in synchronization with the opening of the switch SW3. The switching operation of the SWᵣₛₜ is further controlled, for example, such that it is closed in synchronization with the start of the second period, which is repeated on a certain cycle, and is opened at the time when the time period T corresponding to the gray level has elapsed from the start of the second period P2, only in the case where a gray level within the first gray level range is to be displayed on the selected pixel PX.

In the first and second embodiments, the pixel PX employs the circuit configuration shown in FIG. 1. Various modifications can be made to the pixels PX.

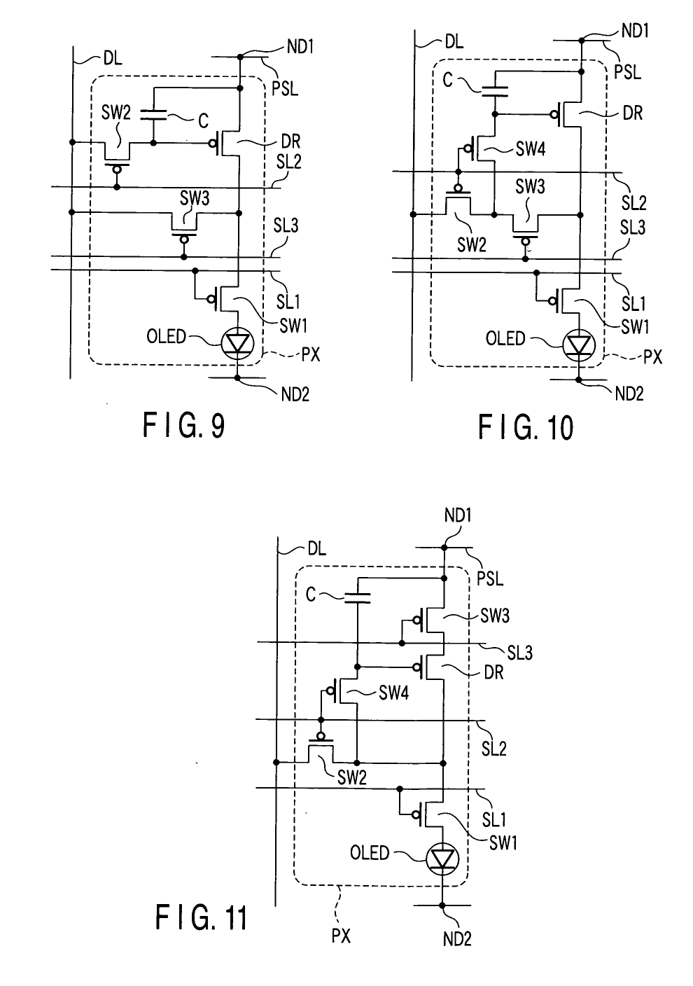

FIG. 9 is an equivalent circuit diagram showing a modified example of the pixel PX. This pixel PX has a structure similar to that of the pixel PX shown in FIG. 1 except that the switch SW2 is connected between the control terminal, that is, gate of the drive control element DR and the video signal line DL and that the switch SW3 is connected between the second terminal, that is, drain of the drive control element DR and the video signal line DL.

When the display shown in FIG. 1 employs the pixel circuit shown in FIG. 9, it can be driven by the method described in the first or second embodiment. In this case, the effects described in the first or second embodiment can be produced.

FIG. 10 is an equivalent circuit diagram showing another modified example of the pixel PX. This pixel PX has a structure similar to that of the pixel shown in FIG. 1 except that it further includes a switch SW4. Specifically, in the pixel PX shown in FIG. 10, one terminal of the switch SW2 is connected to the video signal line DL. The switch SW3 is connected between the other terminal of the switch SW2 and the second terminal, that is, drain of the drive control element DR. The switch SW4 is connected between the control terminal, that is, gate of the drive control element DR and the terminal of the switch SW2 which is connected to the switch SW3.

When the display shown in FIG. 1 employs the pixel circuit shown in FIG. 10, it can be driven by the method described in the first or second embodiment. In this case, the effects described in the first or second embodiment can be produced. In addition, since the pixel circuit includes the switch SW4, the pixel circuit is advantageous to prevent electric charges accumulated in the capacitor C from leaking during the effective display period.

FIG. 11 is an equivalent circuit diagram showing another modified example of the pixel PX. This pixel PX has a structure similar to that of the pixel shown in FIG. 10 except that the switch SW3 is connected differently. Specifically, in the pixel PX shown in FIG. 11, the switch SW2 is connected between the second terminal, that is, drain of the drive control element DR and the video signal line DL. The switch SW3 is connected between the first terminal, that is, source of the drive control element DR and the first power supply terminal ND1. The switch SW4 is connected between the second terminal, that is, drain of the drive control element DR and the control terminal, that is, gate of the drive control element DR.

When the display shown in FIG. 1 employs the pixel circuit shown in FIG. 11, it can be driven by the method as described in the first or second embodiment. In this case, the effects described in the first or second embodiment can be produced.

This pixel circuit allows a current to be passed through the switch SW3 during both the first period P1 and effective display period. Therefore, even when the pixels vary in the on-state resistance of the switch SW3, it is possible to eliminate the influence of the variation on the display quality.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising a video signal line, and pixels arranged along the video signal line, each of the pixels comprising:
a drive control element including a control terminal, a first terminal, and a second terminal which outputs a current at a magnitude corresponding to a voltage between the control terminal and the first terminal;
a capacitor connected between a constant-potential terminal and the control terminal; and
a display element whose optical characteristic changes in accordance with a magnitude of current flowing through the display element,
wherein the display is configured to sequentially execute first and second operations during a write period and execute a display operation during an effective display period following the write period in a case where a grayscale level within a first grayscale range is to be displayed on the pixel, the first operation including making a first constant-current flow through the video signal line for a given length of time while connecting the first terminal to a first power supply terminal and connecting the second terminal and the control terminal to the video signal line, the second operation including making a second constant-current flow through the video signal line in a flow direction of the first constant-current while breaking a connection between the first terminal and the first power supply terminal and/or a connection between the second terminal and the control terminal and connecting the control terminal to the video signal line, and the display operation including making a drive current flow through the display element while breaking the connection between the second terminal and the control terminal and a connection between the control terminal and the video signal line, connecting the first terminal to the first power supply terminal, and connecting the display element between the second terminal and a second power supply terminal, and
wherein the display is further configured to cause a difference between grayscale levels within the first grayscale range by changing a time period during which the second constant-current flows through the video signal line.

2. The display according to claim 1, wherein the display is further configured to sequentially execute the first operation and a third operation during the write period and execute the display operation during the effective display period in a case where a grayscale level within a second grayscale range is to be displayed on the pixel, the third operation including making a third constant-current flow through the video signal line in a direction opposite to the flow direction of the first constant-current while breaking the connection between the first terminal and the first power supply terminal and/or the connection between the second terminal and the control terminal and connecting the control terminal to the video signal line, and
wherein the display is further configured to cause a difference between grayscale levels within the second grayscale range by changing a time period during which the third constant-current flows through the video signal line.

3. The display according to claim 1, wherein the display is further configured to execute a third operation during the write period and execute the display operation during the effective display period in a case where a grayscale level within a second grayscale range is to be displayed on the pixel, the third operation including making a current at a magnitude corresponding to a magnitude of a video signal flow through the video signal line for a given length of time while breaking the connection between the first terminal and the first power supply terminal and/or the connection between the second terminal and the control terminal and connecting the control terminal to the video signal line.

4. The display according to claim 1, wherein each of the pixels further comprises first to third switches, the first terminal is connected to the first power supply terminal, the first switch and the display element are connected in series between the second terminal and the second power supply terminal, the second switch is connected between the control terminal and the video signal line, and the third switch is connected between the second terminal and the control terminal.

5. The display according to claim 1, wherein each of the pixels further comprises first to fourth switches, the first terminal is connected to the first power supply terminal, the first switch and the display element are connected in series between the second terminal and the second power supply terminal, a terminal of the second switch is connected to the video signal line, the third switch is connected between the second terminal and another terminal of the second switch, and the fourth switch is connected between the control terminal and the terminal of the second switch to which the third switch is connected.

6. The display according to claim 1, wherein each of the pixels further comprises first to fourth switches, the first switch and the display element are connected in series between the second terminal and the second power supply terminal, the second switch is connected between the second terminal and the video signal line, the third switch is connected between the first terminal and the first power supply terminal, and the fourth switch is connected between the second terminal and the control terminal.

7. The display according to claim 1, wherein each of the pixels further comprises first to third switches, the first terminal is connected to the first power supply terminal, the first switch and the display element are connected in series between the second terminal and the second power supply terminal, the second switch is connected between the control terminal and the video signal line, and the third switch is connected between the second terminal and the video signal line.

8. The display according to claim 1, wherein the display element is an organic EL element.

9. A display comprising a video signal line driver, a video signal line connected to the video signal line driver, and a pixel which comprises:
a drive control element including a control terminal, a first terminal, and a second terminal which outputs a current at a magnitude corresponding to a voltage between the control terminal and the first terminal;
a capacitor connected between a constant-potential terminal and the control terminal; and
a display element whose optical characteristic changes in accordance with a magnitude of current flowing through the display element, wherein the display is configured to sequentially execute first and second operations, the first operation including making the video signal line driver output a first constant-current to the video signal line for a given length of time while connecting the first terminal to a power supply terminal and connecting the second terminal and the control terminal to the video signal line, and the second operation including making the video signal line driver output a second constant-current to the video signal line while connecting the first terminal to the power supply terminal and disconnecting the second terminal from the video signal line, and
wherein the display is further configured to control the voltage between the control terminal and the first terminal in accordance with a time period over which the video signal line driver outputs the second constant-current to the video signal line.

10. The display according to claim 9, wherein the pixel further comprises first to third switches, the first switch is connected between the second terminal and the display element, the second switch is connected between the control terminal and the video signal line, and the third switch is connected between the second terminal and the control terminal.

11. The display according to claim 9, wherein the pixel further comprises first to fourth switches, the first switch is connected between the second terminal and the display element, a terminal of the second switch is connected to the video signal line, the third switch is connected between the second terminal and another terminal of the second switch, and the fourth switch is connected between the control terminal and the terminal of the second switch to which the third switch is connected.

12. The display according to claim 9, wherein the pixel further comprises first to fourth switches, the first switch is connected between the second terminal and the display element, the second switch is connected between the second terminal and the video signal line, the third switch is connected between the first terminal and the power supply terminal, and the fourth switch is connected between the second terminal and the control terminal.

13. The display according to claim 9, wherein the pixel further comprises first to third switches, the first switch is connected between the second terminal and the display element, the second switch is connected between the control terminal and the video signal line, and the third switch is connected between the second terminal and the video signal line.

14. The display according to claim 9, wherein the display element is an organic EL element.

15. A method of driving a display comprising a video signal line, and pixels arranged along the video signal line, each of the pixels comprising a drive control element including a control terminal, a first terminal, and a second terminal which outputs a current at a magnitude corresponding to a voltage between the control terminal and the first terminal, a capacitor connected between a constant-potential terminal and the control terminal, and a display element whose optical characteristic changes in accordance with a magnitude of current flowing through the display element, comprising:
sequentially executing first and second operations during a write period and executing a display operation during an effective display period following the write period in a case where a grayscale level within a first grayscale range is to be displayed on the pixel, the first operation including making a first constant-current flow through the video signal line for a given length of time while connecting the first terminal to a first power supply terminal and connecting the second terminal and the control terminal to the video signal line, the second operation including making a second constant-current flow through the video signal line in a flow direction of the first constant-current while breaking a connection between the first terminal and the first power supply terminal and/or a connection between the second terminal and the control terminal and connecting the control terminal to the video signal line, and the display operation including making a drive current flow through the display element while breaking the connection between the second terminal and the control terminal and a connection between the control terminal and the video signal line, connecting the first terminal to the first power supply terminal, and connecting the display element between the second terminal and a second power supply terminal; and
causing a difference between grayscale levels within the first grayscale range by changing a time period during which the second constant-current flows through the video signal line.

16. The method according to claim 15, further comprising:
sequentially executing the first operation and a third operation during the write period and executing the display operation during the effective display period in a case where a grayscale level within a second grayscale range is to be displayed on the pixel, the third operation including making a third constant-current flow through the video signal line in a direction opposite to the flow direction of the first constant-current while breaking the connection between the first terminal and the first power supply terminal and/or the connection between the second terminal and the control terminal and connecting the control terminal to the video signal line, and
causing a difference between grayscale levels within the second grayscale range by changing a time period during which the third constant-current flows through the video signal line.

17. The method according to claim 15, further comprising executing a third operation during the write period and executing the display operation during the effective display period in a case where a grayscale level within a second grayscale range is to be displayed on the pixel, the third operation including making a current at a magnitude corresponding to a magnitude of a video signal flow through the video signal line for a given length of time while breaking the connection between the first terminal and the first power supply terminal and/or the connection between the second terminal and the control terminal and connecting the control terminal to the video signal line.
